(19) United States
(12) Patent Application Publication
(10) Pub. No.: US 2026/0134135 A1
(43) Pub. Date: May 14, 2026

(54) ENTERPRISE EVENT PLATFORM IN A COMPLEX ORGANIZATION

(71) Applicant: HSBC Global Services (UK) Limited, London (GB)

(72) Inventors: Vinod Himmat CHAVAN, Pune (IN); Matthew Philip LEGERTON, Hayle (GB); Harish SHETTIGAR, Pune (IN); Shivaji NIKAM, Watford (GB); Geoff Alan FORD, Kent (GB)

(21) Appl. No.: 19/442,967

(22) Filed: Jan. 7, 2026

(51) Int. Cl. G06F 21/62; H04L 9/06; H04L 9/30; H04L 9/32

(52) U.S. Cl. CPC G06F 21/6218; H04L 9/0631; H04L 9/3066; H04L 9/3252; G06F 2221/2141

(57) ABSTRACT

This is an enterprise event platform (EEP) comprising distributed event abstraction layer (EAL) instances configured within jurisdictional boundaries and a central broker that transports only event metadata. Publishers submit events to local EALs where content is validated, encrypted, durably cached, and linked to a metadata record that is published to a central event broker. Subscribers register with a local EAL using cryptographic identity (ECDSA) and ephemeral key exchange (ECDH), receive per-subscriber access rules from a data access control (DAC) service and consume event streams through the local EAL. For each event, the subscriber's local EAL requests the payload from the remote EAL designated in the event metadata. The remote EAL transforms the event according to the subscriber's access rules, encrypts with a subscriber symmetric key, and returns the secured, tailored payload for delivery to the subscriber.

### BACKGROUND

Enterprises are increasingly adopting event-driven architectures to achieve near real-time data propagation and responsiveness. Conventional messaging and streaming brokers provide basic ordering, pub/sub, and replay features but lack enterprise-grade capabilities required by global organizations.

Existing approaches either centralize brokers in ways that breach sovereignty rules, duplicate brokers and data across jurisdictions with high cost/complexity, or enforce static, coarse access rules that fail to meet dynamic policy requirements and per-use-case controls. There is a need for an enterprise event platform that delivers broker-agnostic, per-subscriber compliant event streams with strong cryptography, secure inter-instance collaboration, and seamless coordination with data platforms.

Modern enterprises desire operating with maximized autonomy using their own technology selections, wherein they would be free to introduce event driven architecture if required. However, this creates challenges if domains need to communicate to each other via events. This issue is amplified when the communication traverse jurisdictional boundaries that impose data controls via policy statements that the enterprise must adhere to or face severe financial or legal penalties.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

Disclosed are systems and methods for an enterprise event platform (EEP) comprising distributed Event abstraction layer (EAL) instances configured within jurisdictional boundaries and a central broker that transports only event metadata. Publishers submit events to local EALs where content is validated, encrypted, durably cached, and linked to a metadata record that is published to a central event broker. Subscribers register with a local EAL using cryptographic identity (ECDSA, Elliptic Curve Diffie-Hellman) and ephemeral key exchange (ECDH, Elliptic Curve Digital Signature Algorithm), receive per-subscriber access rules from a data access control (DAC) service based on a triple parameter (subscriber identity, subscriber location, subscriber use case), and consume event streams through the local EAL. For each event, the subscriber's local EAL requests the payload from the remote EAL designated in the event metadata. The remote EAL transforms the event according to the subscriber's access rules, encrypts with a per-subscriber symmetric key, and returns the secured, tailored payload for delivery to the subscriber.

In certain embodiments, EAL instances exchange only the minimum information necessary to produce compliant outputs, using shared AES-GCM keys derived via ECDH and signed via ECDSA to establish trust, integrity, and confidentiality. The central broker contains no regulated payload data, only lightweight metadata identifying the authoritative EAL instance and an EAL-level event identifier. The architecture yields low-latency, secure, jurisdictionally compliant event distribution with flexible infrastructure and product decoupling.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWING

FIGS. 1a, 1b and 1c are an architecture diagram of the enterprise event platform in accordance with subject description.

FIG. 2 is a diagram of treatment of identity, identity location, and use case of subscriptions using the enterprise event platform in accordance with subject description.

FIG. 3 is a diagram of a process of declaring a subscriber utilizing the enterprise event platform in accordance with subject description.

FIG. 4 is a diagram of interaction of a subscriber with an event abstraction layer in accordance with subject description.

FIG. 5 is a diagram of identification of a subscriber with an event abstraction layer in accordance with subject description.

FIG. 6 is a diagram of a self-service portal of the enterprise event platform in accordance with subject description.

### DETAILED DESCRIPTION

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

Modern organizations are rapidly shifting toward event-driven architectures to facilitate real-time dataflows and enhance decision-making processes. However, traditional message brokers provide limited support for enterprise-level requirements, especially when handling jurisdiction-specific compliance, dynamic access controls, and unified data management.

Additionally, conventional systems face challenges with cross-domain event propagation, access management, and schema evolution. There is a growing need for automated event lifecycle management and enhanced observability for auditing and reconciliation purposes. The lack of centralized governance across these platforms increases risk of data silos and compliance failures. Modern organizations require a plethora of advanced capabilities to support the event management needs of global organizations, which may require event planning and coordination across a plurality of jurisdictions in an automated manner.

Organizations are often required to comply with complex and evolving data sovereignty laws and cross-border data transfer regulations. These constraints vary not only by the identity of the data consumer, but also by their location, the intended use case, and even the time at which the data is accessed. Existing brokers do not provide mechanisms to enforce these nuanced requirements, leading to potential compliance risks.

Enterprises may often require the ability to enforce data access controls at the attribute level, with policies that can change dynamically in response to regulatory updates or business needs. Static, coarse-grained access controls are insufficient, as they cannot accommodate the need for per-subscriber, per-use-case data masking, redaction, or denial.

Large organizations are composed of autonomous domains, each with its own technology stack and data models. These domains are autonomous in that their technology authorities can select the tools and design patterns and approaches and data/event structures that maximize value to the specific customers, which is efficient as many operation processes remain within the domains. Additionally, current systems face challenges with cross-domain event propagation, access management, inconsistent use of data, duplicate events publication, and schema evolution.

There is a need for federated governance of event definitions and schemas, allowing domains to operate independently while ensuring consistency and compliance for inter-domain event flows. Existing solutions often result in tool or vendor lock-in, limiting flexibility. In complex organizations, managing event-driven architecture between systems spread across different geographies and jurisdictions is a complex task.

Enterprises must propagate events across domains and jurisdictions while maintaining the lowest possible latency and strict compliance with local regulations. Current approaches either centralize brokers in ways that breach sovereignty rules or duplicate brokers and data across jurisdictions, resulting in high cost and complexity.

Organizations require the ability to replay historical events for new subscribers or for audit purposes. The replayed events must reflect the applicable policies either at the time of replay or at the time of original publication, depending on the use case. Existing systems do not support this level of policy-driven replay.

Mergers, acquisitions, technology services agreements, and regulated bank resolution or insolvency scenarios demand rapid isolation, masking, auditability, and reconfiguration of event flows. Current architectures require significant infrastructure changes to accommodate these needs.

Seamless integration with data platforms is necessary for jurisdictional event storage and analytics alignment. Existing event brokers do not provide native support for such integration, leading to data silos and inconsistent governance.

There is a need for an enterprise event platform that delivers broker-agnostic, per-subscriber compliant event streams with strong cryptography, secure inter-instance collaboration, and seamless coordination with data platforms.

The following description sets forth illustrative embodiments of integrated systems, devices, and methods that relate to an enterprise event platform. The invention relates to computer-implemented systems and methods for event-driven data distribution in large organizations. In various implementations, the enterprise event platform (EEP) may comprise broker-agnostic enterprise event platforms that provide secure, low-latency, first-in-first-out (FIFO) event delivery with dynamic, per-subscriber data access controls and jurisdictional compliance across multiple domains, regions, and legal entities.

The EEP enables organizations to efficiently manage the lifecycle of events between systems, while ensuring regulatory compliance, schema validation, and access control. The platform leverages message brokers as the backbone but introduces an abstraction layer that facilitates integration between heterogeneous systems and platforms.

The EEP handles event schema validation before publishing events on the broker, granular access management, self-service capability to register new application on the enterprise event platform, and jurisdictional constraints to ensure the integrity and compliance of data flows with standard definition of schema.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

The terminology used herein is for the purpose of describing particular examples only and is not intended to be limiting. As used herein, the singular forms “a,” “an,” and “the” may be intended to include the plural forms as well, unless the context clearly dictates otherwise. As example, “a” vent may include multiple vents, and the like.

As used herein, the term “and/or” includes any and all combinations of one or more of the associated listed items. Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Words such as “then,” “next,” etc. are not intended to limit the order of the steps; these words are simply used to guide the reader through the description of the methods.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an embodiment, but any compositions, materials, components, elements, features, integers, operations, and/or process steps that do not materially affect the basic and novel characteristics may be included in the embodiment.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example embodiments may be combined in or with various other example embodiments in any permutational or combinatory manner. Different aspects or elements of example embodiments, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

While specific aspects of the disclosure have been provided hereinabove, the disclosure may, however, be embodied in many different forms and should not be construed as necessarily being limited to only the embodiments disclosed herein. Rather, these embodiments may be provided so that this disclosure is thorough and complete, and fully conveys various concepts of this disclosure to skilled artisans.

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, may be at least partially performed via at least one entity or actor in any manner.

While particular aspects have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that may be within the scope of this application.

Unless defined otherwise, all technical and scientific terms used herein have the same meanings as commonly understood by one of ordinary skill in the art.

Numerous specific details are set forth to provide a thorough understanding of one or more embodiments of the described subject matter. It is to be appreciated, however, that such embodiments can be practiced without these specific details.

The present invention is an enterprise event platform (EEP) that enables organizations to efficiently manage the lifecycle of events between systems, while ensuring regulatory compliance, schema validation, and access control. The EEP utilizes an abstraction layer that facilitates integration between heterogeneous systems and platforms. The EEP may be configured to handle event schema validation before publishing events on the broker, manage granular access, and register new applications through a self-service capable portal. The EEP may be configured with jurisdictional constraints to ensure the integrity and compliance of dataflows with standard definition of schema.

The EEP comprises a design concept that enables transferred information and/or action to be understood by a recipient, with minimal or no intermediary interaction with publishing teams. This may be achieved through a common design standard for data within events, a number of controls that ensure that such common design standards are applied, and a widely available data discovery capability. The information may be transferred compliantly across any jurisdictional boundaries, wherein the transfer mechanism may be agnostic to either the publishing or subscribing domain's tooling and design choices.

The EEP comprises a few key elements, including an event broker layer, an abstraction layer, and a self-service portal.

The event broker layer comprises a market leading event broker that will provide a large list of capabilities out of the box such as event ordering, replay functionality for defined periods, short term event store capability, etc.

The abstraction layer may be implemented to facilitate loose coupling between domains and the event platform implementation, ensuring a standard approach to event sharing and allow both the publishing and subscribing domain and the event platform to be as autonomous as possible. A middleware component that standardizes and validates incoming data events, ensuring consistency and compatibility across diverse business domains. For the EEP, this provides flexibility in how the event platform capabilities are delivered, allowing use of different underlying technologies as required.

The self-service portal provides comprehensive self-service capabilities for consumers to manage event-related activities and new application onboarding on the event platform independently.

The EEP ensures that subscribers can subscribe to events containing well-defined data, which is transferred with minimal latency while guaranteeing jurisdictional compliance. This includes both real-time events and replays of historic events, ensuring compliance even if jurisdictional policies change over time.

The EEP comprises a plurality of event abstraction layers (EAL). An abstraction layer is an API-based module that abstracts the interaction between publishers and subscribers, allowing them to interact with local instances without being aware of the entire EEP topology. This decouples the architecture from specific event broker products and simplifies management.

The EEP comprises a data access control (DAC). A dedicated DAC service models jurisdictional policies into control policies, defines identities and locations, and provides access rules for data attributes based on the subscriber's identity, location, and use case. The DAC also notifies the EEP of access rule changes as they come into effect.

Each subscriber is assumed to have a unique set of data access rules, generated by the data access control (DAC) service. These rules are applied dynamically to ensure that the subscriber receives events that are compliant with the latest jurisdictional policies or as they would have been at the time of the event's original publication, depending on the use case.

The EEP is designed with an event broker agnostic approach. Metadata that has no jurisdictional data policy impacts is stored in a single event broker installation, simplifying infrastructure capacity planning. The geographical location of the event broker is chosen based on latency, cost, and supportability, without jurisdictional concerns.

The EEP comprises a data platform (DP), wherein event data can only be stored within its originating jurisdiction or in a DP instance that the jurisdiction approves. This ensures compliance with strict data residency requirements and prevents unauthorized data movement across borders.

The DP includes an event store as part of its design. This event store allows for the replay of historic events while ensuring that the data remains jurisdictionally compliant. The event store is geographically distributed, with instances deployed in locations approved by the respective jurisdictions.

Each subscriber, including external parties under a TSA, receives a unique stream of events. These streams are adjusted based on the DAC-generated access rules, ensuring that only the agreed-upon data attributes are shared with the organization.

The EEP comprises a plurality of EAL instances. Each EAL instance may comprise a unique cryptographic identity, further comprising an elliptic curve digital signature algorithm (ECDSA) key pair and an elliptic-curve Diffie-Hellman (ECDH) key pair issued by an Identity Provider (IdP).

An identity may be defined by an ECDSA private key, issued by an IdP, that only the identity has access to. The IdP also provides the ECDH private key, again securely known only to the identity, for key exchange actions. The IdP can provide the public keys for both to any interested party. The location of an identity can be determined via a non-spoofable mechanism.

ECDSA (Elliptic Curve Digital Signature Algorithm) behaves as a digital signature. It proves a user's identity, similar to signing a document with a user's unique signature. In the platform, each subscriber and event abstraction layer (EAL) may have an ECDSA key pair. The private key may be kept secret and used to sign messages, while the public key is shared so others can verify the signature and confirm identity. This ensures only authorized parties can register and interact securely.

ECDH (Elliptic Curve Diffie-Hellman) is used for secure key exchange. Imagine two people agreeing on a secret handshake that only they know, even if others are watching. ECDH allows the subscriber and EAL to create a shared secret key, which is then used to encrypt messages between them. This means that even if someone intercepts the communication, they cannot read the contents without the shared key.

A DP may be incorporated with the EEP to ensure data attributes are well defined. The DP may further define access and privacy enhancement control policies. The EEP may be constructed under the assumption that sufficient instances of DP may be deployed geographically, such that the data for any given jurisdiction may be stored in one of the DP instances without requiring additional data privacy controls. Each of the DP instance may be assumed to be trusted to hold data securely and apply data control to any consumers.

In various embodiments, the DP may include an event store as part of its design from whose events the data asset records may be manufactured. This may ensure that the data assets are generated in near real-time using the same data passed by the EEP to subscribers, thereby ensuring consistency for data consumers.

The EEP may comprise a DAC service. The DAC may be configured to model jurisdictional policies into control policies, model identities and locations, and provide access rules for sets of data attributes. The DAC may notify the EEP of access rule changes for subscribers.

The EEP may be designed with a number of initial considerations. Given the unknown nature of subscribers, event data may only be stored within its originating jurisdiction, or in the DP instance that the jurisdiction approves. This consideration limits access to event data from remote locations, thereby necessitating an abstraction function to transfer information without compromising jurisdiction boundaries.

Further, each subscriber must be assumed to have a unique set of data access rules, based on the subscriber triple parameters (subscriber identity, subscriber location, subscriber use case), that will be generated by the DAC service. Therefore, a unique stream of events, in which each event data that has been access rule adjusted, is required for each subscriber. The subscriber should not need to be aware of the location of the publisher of events. Instead, the subscriber should simply request the event stream to start from a given point-in-time and then receive events.

If each event can be identified via metadata that has no jurisdictional data policy impacts, then this can be stored into a single event broker installation (such as Apache Kafka). Additionally, the standardized size of the event containing the metadata allows for simplified infrastructure capacity planning.

The geographical location of the event broker can be chosen based on latency, cost, supportability and other considerations. Due to the above considerations, introducing an API-based EAL allows both publishers and subscribers to interact with a local instance, without having to be aware of the entire EEP topology. Additionally, the EAL removes tight coupling to any given event broker product, which allows the EEP's internal event broker to be managed/replaced with minimal/no impact to publishers or subscribers. The metadata based use of an event broker combined with EAL also removes the challenges of regulatory imposed technology selections.

The EEP comprises multiple components that collectively ensure secure, scalable, and compliant event handling. It addresses key challenges like data sovereignty, access control, and legacy integration while supporting modern event brokers.

The EEP comprises an event broker abstraction layer (or event abstraction layer, or EAL). This layer aggregates and hides implementation details of various event brokers. It provides a unified interface for event producers and consumers, ensuring flexibility in broker selection. This abstraction allows organizations to switch brokers without affecting downstream applications. The abstraction layer comprises unified integration for even publishing and subscribing. The abstraction layer may be implemented with a broker-agnostic design, allowing replacement of underlying event systems without business disruption. Broker selection logic may be implemented to route events to different brokers based on metadata.

The EEP comprises a schema registry, ensuring that all events conform to predefined formats. The schema registry enables interoperability between different systems. The schema registry stores schemas and provides schema validation at runtime, ensuing data consistency. The schema registry may be implemented with versioning support, allowing systems to evolve while maintaining backward compatibility. The schema registry may comprise schema validation API to validate incoming events before publishing on broker. The schema registry enables centralized schema governance, ensuring data consistency across the enterprise.

The EEP comprises an access control engine, enforcing fine-grained security policies for event publication and subscription. Using a combination of role-based access control (RBAC), policy-based access control (PBAC), and attribute based access control (ABAC), the access control engine defines who can interact with the platform and how. The access control engine may be configured to manage event-level access policies based on user roles and event metadata. The access control engine may be incorporated with self-service portals for defining access policies, reducing the dependency on platform administrators. The access control engine enables integration with data platform systems to manage identities to manage identities and permissions based on region.

The EEP comprises a jurisdictional compliance manager, which ensures that event flows comply with local data regulations. The jurisdictional compliance manager coordinates cross-border data flows, ensuring compliance with regulations like GDPR, CCPA, and others. The manager automatically applies data masking, encryption, or routing rules based on event metadata. The jurisdictional compliance manager may be configured to manage data flow restrictions based on jurisdictional boundaries. The jurisdictional compliance manager facilitates compliance audit logs tracking event flows and access for regulatory purpose. It also manages data anonymization or masking for sensitive information.

The EEP may comprise a self-service portal, which may be implemented to maximize self-service capabilities and minimize impact when changes occur to the EEP. It aims to empower domains to independently manage their event-related activities, fostering a culture of autonomy and efficiency. This characteristic supports the overall objective of decentralizing event management and reducing reliance on centralized teams. The self-service portal may enable new event registration though self-service portal, new producer/consumer onboarding, access management, operations and observability management, and platform Management.

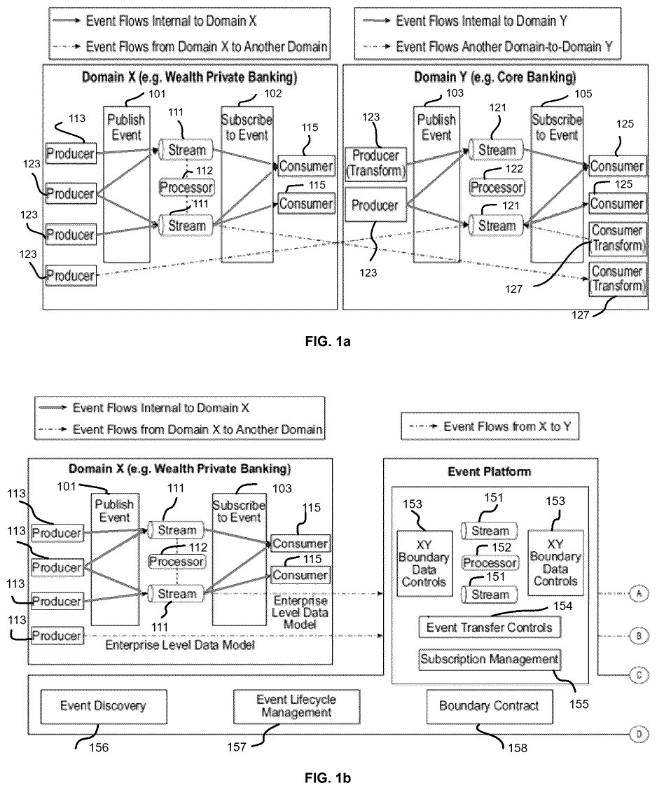

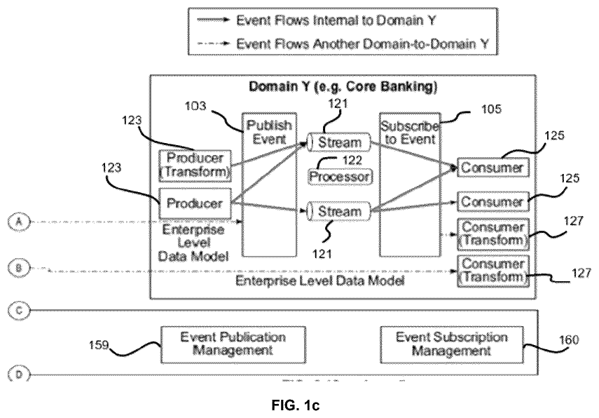

Referring to FIG. 1-c, a block diagram of logical architecture for the EEP is provided. The diagram illustrates two domains, wherein event streams of each are organized in respective domains, but consumers may traditionally be unable to discover or subscribe to other domains.

In FIG. 1a, events which are published and consumed within domain are shown. These events are using domain specific event platform. But the events which are published to consume by another domain will integrate with producing event platform. In this example, producers 113 in Domain X generate streams 111 through a publishing event layer 101. Consumers 115 may receive published streams 111 from the event subscription layer 102. Similarly, producers 123 in Domain Y may publish to stream 121 through the publishing event layer 103, which intern is consumed by consumer 125 through the event subscription layer 105. In order for a producer 113 to stream to stream 121 across domain, producers and consumers need to use each domain specific publishing or subscription layers. In practice, this may not be practical or possible given the jurisdictional boundaries and requirements.

Events which are published and consumed outside domain may experience another set of challenges. In this example, point-to point communication is conducted with limited standardization of event specification. There may not be access control for regulatory implications and data compliance for cross domains. Generation of duplicate events between different domains as per domain requirement may occur. There may be attempts of re-work and complications while making the change to the domain specific event platform. These factors make the conventional event platforms limiting to the more expansive needs of modern enterprises.

Referring to FIG. 1b-c, the EEP may be designed to coordinate events published in multiple domains. Multiple subscribers or consumers 115/125 may desire to access events published in other domains 111/121. Due to jurisdictional restraints, events published in one domain may not be discoverable by subscribers in other domains, due to restrictive nature of jurisdictional policies. In this example, the producers 113 may not be able to generate events from publishing event layer 101 to the cross domain stream 121, wherein the consumers 125 may be able to discover the events. Vice versa, producers 123 may not produce events that would be discoverable by consumers 115.

As such, the EEP utilizes an event abstraction layer, which may act as coupling between domains. The abstraction layer may comprise domain boundary data controls 123, even transfer controls 154, and subscription controls 155. The EEP may comprise a consolidated stream 151 coupled with a processer 152, wherein the subscriptions from stream 111 and stream 121 may be published to streams 151. The EEP may also comprise an event discovery 156, event life cycle management 156, boundary contract 158, event publication management 159, and event subscription management 160.

The event abstraction layer may extract metadata instances from the event payloads from published events, wherein the metadata may be scrubbed of any restricting regulatory data. The metadata may then be transferred to subscribers of other domains through event streams, such that the events may be discovered by subscribers in such domains, without violating compliance of jurisdictional and regulatory barriers.

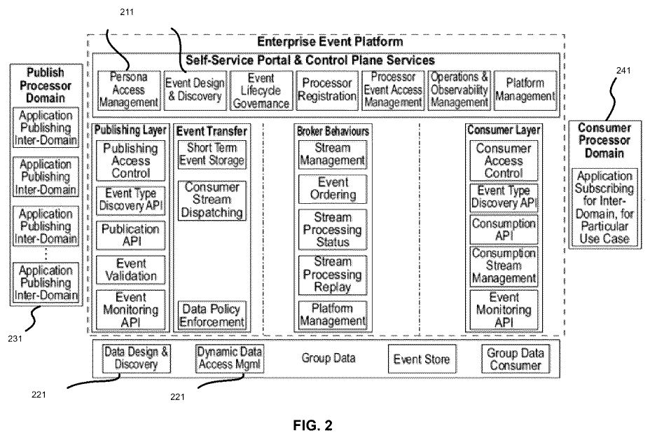

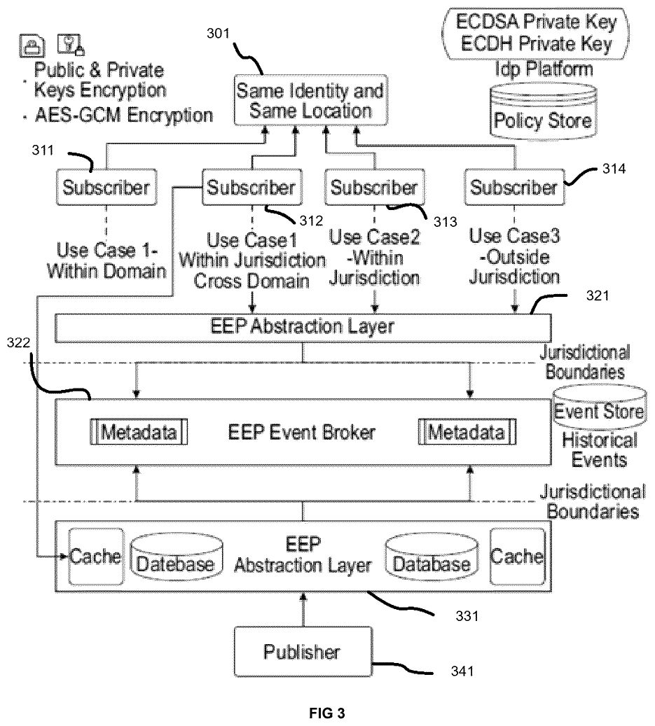

Referring to FIG. 2, a block diagram of an enterprise event platform (EEP) is provided. The EEP comprises a self-service portal 211 and control plane services. The control plane services may enable personal access management, event design and discovery, event lifecycle governance, processor registration, processor event access management, operations and observability management, and platform management.

The EEP may comprise a publishing layer, wherein the publishing layer enables publishing access control, event type discovery API, publication API, event validation, and event monitoring API.

The publishing layer may be connected to an event transfer module, comprising short term event storage, consumer stream dispatch, and data policy enforcement.

The EEP further comprises a consumer layer, wherein the modules may enable consumer access control, event type discovery API, consumption API, consumption stream management, and event monitoring API.

The EEP comprises publish processor domain modules 231, which may contain a plurality of application publishing inter-domain. On the other hand, a consumer processor domain 241 may be provided for particular use case.

Referring to FIG. 3, an example of a software architecture for the EEP is provided. The figure illustrates an event subscription architecture, showing how identity, encryption, and data flows are handled across domains and jurisdictions. It centers on an event exchange platform with policy-driven controls and cryptographic protections, and contrasts four subscription scenarios based on where the subscriber sits relative to the publisher. In subscriber registration process illustrated in FIG. 3, the subscriber uses ECDSA to prove their identity and ECDH to establish a secure channel with the EAL. The process involves exchanging public keys, signing requests, and generating a unique identifier for the subscriber.

The EEP comprises a publisher and a plurality of subscribers. The publisher may be configured to publish events. The subscribers may be configured to register subscriptions to receive those events. Multiple subscriber instances are shown to represent different use cases.

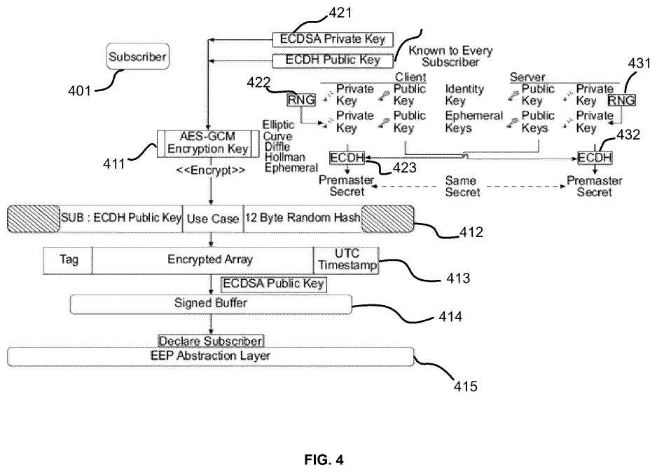

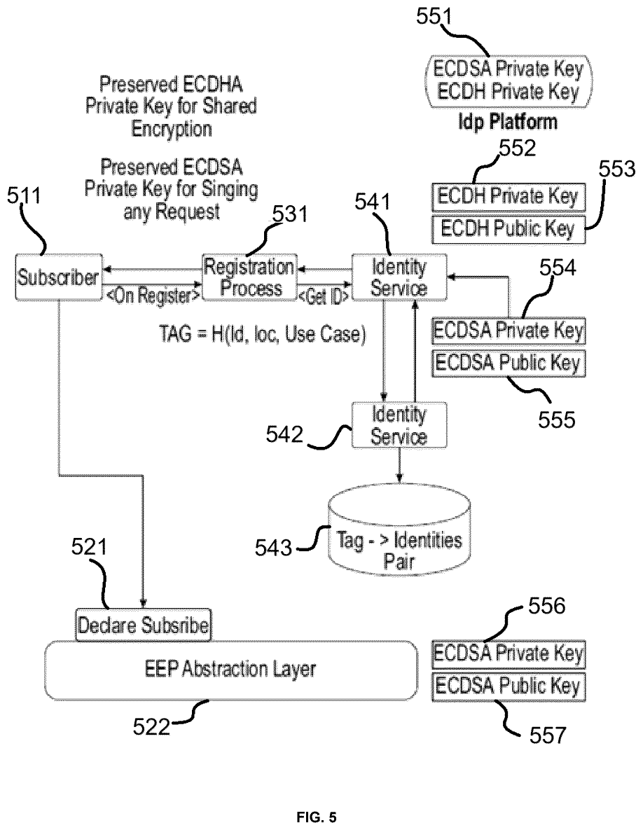

During event publication and consumption (FIGS. 4 and 5), ECDSA continues to verify identities and sign requests, while ECDH ensures that event data is encrypted and only accessible to the intended recipient. This combination protects against impersonation, eavesdropping, and replay attacks.

The EEP comprises an identity provider platform (IdP) and a policy store. Identity and access are governed by the identity provider, at times with a policy store. Policies may determine whether and how a subscriber can receive events based on identity, domain, and jurisdiction.

The EEP may comprise an event abstraction layer (EAL). The EAL is an intermediary layer that enforces policies, handles metadata, and brokers event delivery. It may be implemented on both sides of jurisdictional boundaries and serves as the primary control plane for subscriptions.

The EEP may comprise an event broker and event store. The event broker handles real-time event distribution, while the event store retains historical events. Both are associated with metadata to support governance and replay.

The EEP may comprise data stores and caches. Each side of the EEP abstraction layer may comprise a database and cache to optimize retrieval and comply with locality constraints.

The EEP may comprise jurisdictional boundaries, which determine which controls and cryptographic strategies are applied.

The EEP may comprise public/private key encryption. In an example, the EEP may comprise symmetric encryption (AES-GCM) for data-in-motion or at-rest protection, and public/private key cryptography for identity-bound operations. Overall, the cryptographic choices are tied to the identity, the identity's location, and the use case of the subscription.

For the ECDSA private key, identity may be confirmed. When the subscriber uses the same identity as recognized by the publisher's trust domain, signatures/attestations are tied to the same ECDSA credential.

For the ECDH private key, location may be confirmed. When operating in the same location context, key agreement via ECDH is highlighted for secure channel establishment.

The figure comprises examples to illustrate four distinct cases that drive policy and encryption posture. First, within same jurisdiction and same domain, a lowest-friction path. Identity alignment and locality allow straightforward policy evaluation, with use of the same identity and local key exchange (ECDH/ECDSA) for channels. Data can traverse within the domain boundary via the EEP layer, broker, cache, and database without cross-boundary transfer.

Second, within same jurisdiction, different domain, a use case is presented with cross-domain trust being required. The IdP/policy store mediates authorization. The EEP abstraction layer enforces domain-to-domain controls; keys and metadata binding ensure only permitted events cross domains. In this use case, the EAL may extract metadata and store in the cache.

Third, with different jurisdiction, same domain, the legal boundary is crossed even though the organizational domain is consistent. Additional jurisdictional controls apply (e.g., localization, data minimization, encryption-at-rest in destination). The EEP layer gates cross-jurisdiction flows, with stronger encryption and metadata tagging to reflect data origin and use constraints.

Lastly, with different jurisdiction and different domain, this use case requires the highest control posture. Both cross-domain trust and cross-jurisdiction compliance apply. Policies likely mandate stricter key management, enhanced metadata handling, and potentially limitations on which events or fields can egress.

With the architecture illustrated in the example, the EEP may enable event planning processes based on the metadata extracted from the EEP abstraction layer. Events originate from the publisher and are ingested and tagged with metadata, which may be extracted and generated by the event abstraction layer. The EEP abstraction layer evaluates subscriber requests against the policy store and IdP-validated identity. Depending on the scenario (1-4 of the above examples), the platform uses a combination of AES-GCM encryption and public/private key encryptions for security. In an example, ECDSA may be used for identity-bound signing and ECDH may be used for secure session establishment.

The EEP event broker may be configured to stream permissible events. In various examples, the event store retains historical records for replay under the same policy constraints. Metadata may be generated, transported, stored, and exchanged through the EEP event broker in a policy compliant manner.

Caches and databases on each side of the boundary may be configured to maintain jurisdictional compliance. The figure illustrates an event-driven system where subscription handling is explicitly shaped by domain and jurisdiction boundaries, with identity and cryptography tightly integrated to enforce policy, privacy, and compliance.

The EEP may be configured to facilitate declaring a subscriber, declaring a publisher, publishing events to event streams, providing event discovery to subscribers, and enabling subscriber event transformation and delivery.

The EEP comprises configurations to uniquely identify a subscriber and securely transfer events to them from the jurisdictional origin.

An identity has two sets of keys, which it receives from the IdP via a secure mechanism: an ECDSA key pair that provide identity of the subscriber (via signing); an ECDH key pair that allow the creation of a shared encryption key with another identity.

The public keys of both are available from the identity provider (IdP), based on a “tag” it has associated to the identity. The EAL has an identity, and all subscribers include an identity.

There it is possible to use the ECDH public key of the EAL, and the ECDH private key of the subscriber, to create a shared AES-GCM encryption key. This will be used to encrypt information shared from the subscriber to the EAL.

The encrypted information comprises a new ECDSA public key. In an example, the subscriber retains the private key securely. The encrypted information comprises the use case of the subscriber. Furthermore, the encrypted information may comprise a random byte array, which may be 12 bytes in an example. This encrypted information is then combined with the tag for the identity of the subscriber and the current UTC time, and this combined information is signed using the private ECDSA of the identity.

The signed combined information is then sent to an EAL API for declaring a subscriber. In an example, the API may be a DeclareSubscriber API method. Through the API, the EAL may be configured to check whether the UTC time of the material is after its internal acceptance window. If it is, then the request may be refused. The subscriber may attempt again at a time within the internal acceptance window.

The EAL may retrieve the ECDSA and ECDH public keys for the tag from the IdP and verify the signature of the signed combined information. This process may be supported by confirming the identity of the subscriber. Once confirmed, the EAL may decrypt the encrypted information using its ECDH private key and the identity's ECDH public key from the IdP.

The EAL may then check whether it recognizes the random byte array previously, such as in recent history stored in a database. If it has, the EAL may recognize this subscriber request as a replay attack and the request is refused. Otherwise, the subscriber may request again, alternatively with a newly generated or unique random byte array.

The EAL may create an internal unique id for the subscriber after confirming its request's validity and identify the subscriber location from their connection details to the EAL. The EAL may request the set of access control rules for the subscriber from the DAC.

The EAL may store the access control rules, the new ECDH public key, and the ECDSA public key against the unique id of the subscriber. The EAL may encrypt the unique id using the shared key created by the new ECDH public key and the ECDH private key of the EAL. Finally, the EAL may sign this encrypted information with the ECDSA private key of the EAL, and respond to the subscriber with this encrypted, signed response.

The combination of short acceptance window (temporally defined by an UTC time window in an example), unknown random byte array within the encrypted material, and use of a one-time ECDH public key, may minimize the possibility for both replay and eavesdropping attacks. Using a byte array provides minimal additional overhead but allows the EAL to separate replay checks from one-time ECDH public key against unique ids. The replay checks may be less secured, whereas the unique ids needs to be highly secured.

The subscriber may verify the source of the signed response. Once verified that the signed response was provided by the EAL, the subscriber may decrypt it to retrieve its unique id. The subscriber may now make further requests to the EAL API using a request that includes the unique id and is signed using the EAL's ECDSA private key. The subscriber may furthermore submit a request that contains a payload encrypted using the subscriber's one-time ECDH private key and the EAL's ECDH public key.

The EAL can both verify the request originates from the subscriber and decrypt the payload. This means that an audit trail of activity, together with event flows, can be easily generated.

This process to declare a subscriber is a shared-nothing approach, meaning multiple identical subscribers will each have their own unique id. This may be particularly relevant when a FIFO processing of events is not required, and where they implement idempotency, as all subscribers will receive all events.

Should a subscriber fail, then it will receive a new unique id on reconnection. For this reason, a heartbeat mechanism is required so that the EAL can detect when a unique id is no longer active.

Referring to FIG. 4, a process to connect the subscriber to the EAL is provided. Each of the subscriber may be assigned an ECDSA private key and an ECDH public key. The ECDSA private key may be known to every subscriber. Both keys may be incorporated into an AES-GCM encryption key. The subscriber, with its unique identity provided by an IdP, may be encrypted as an encrypted array, comprising an ECDH public key, a use case, and a random hash. In this example, the random hash may be a 12 byte random hash.

The encrypted array may further be assigned a tag and a UTC timestamp. An ECDSA public key may be applied, if the encrypted array has its identity confirmed via the process described in FIG. 1-2. The encrypted array may be the converted into a signed buffer or combined information. The EAL therefore completes declaring a subscriber.

Subsequently, the EEP may be configured enable declaring a publisher. A publisher may be any identity, organization, or process that wishes to send events to an event stream for subscribers to consume. Declaring a publisher follows the same pattern as declaring a subscriber, with two key differences. First, a publisher consists only of an identity and a location; there is no use case attached. Second, the declaration request is sent to the publisher's local EAL via an “DeclarePublisher” API, in an example.

When the EAL receives a publisher declaration, it first checks whether the publisher is permitted to publish at all. If not, it rejects the request. If the publisher is authorized, the EAL determines which event streams the publisher is allowed to write to, associates that set of streams with the publisher's unique identifier, and returns a combined response that includes the unique id and the authorized stream set. This response is both encrypted and signed.

If a single process acts as both a subscriber and a publisher, it will receive separate unique identifiers and separate shared encryption keys for each role. From this point forward, all communications between the process and the EAL are signed using the identity's ECDSA private key, include the unique id in plaintext, and carry a payload encrypted with the relevant shared key.

The unique id is intentionally transient and “shared-nothing.” This design allows multiple publishers to operate with the EAL independently and concurrently without cross-contamination of state or keys.

Referring to FIG. 5, a process to manage subscriber identity via the enterprise event platform (EEP) abstraction layer is provided. The event abstraction layer (EAL) may hold a pair of ECDSA private/public keys. An ECDSA private key may be applied to an identity service, which may be preserved for signing any request. A subscriber may initiate a registration process to obtain an identification, wherein the identity service provides an ECDSA private key. The EEP provides a database for storing a tag and identities pair. The tag may comprise an identification, location, and use case combination. The identity provider (IdP) platform may provide an ECDSA private key and an ECDH private key. As described above, the EEP abstraction layer may declare a subscriber once the ECDSA private key is confirmed.

Upon declaration of the subscriber and publisher, authorized publishers may now call a discovery API for the EAL for one of more of the event streams and retrieve permitted event specifications for each stream. Because there can be more than one event streams, event definitions may evolve incrementally across the publishers without requiring a “stop start” event as the new specification is published.

Event specifications may have a monotonically increasing id, and publishers may be expected to publish events that match the latest specification whenever possible, although the other specifications are permitted. This ensures that the publisher processes are regularly updated, which in turn means that event definition changes are easy to govern and deploy across a wide geographic base of publishers.

Event specifications may determine which event attributes are mandatory or optional. Publishers must include all mandatory attributes and as many optional attributes as possible. The event specifications may determine the type and representation format (when needed) for each attribute. Publishers must transform their data into these types and format as they create the event.

Publishers may establish a monotonic event identifier for each event stream that they will publish events against. The combination of a unique id, event stream id, and event identifier therefore determines the FIFO ordering of events from each specific publisher for the EAL.

All events are published to a publishing API of the EAL. In an example, the identity-signed request is formed of publisher unique id in plain text and encrypted payload. The encrypted payload may comprise event stream id, event identifier, event specification, and event contents

This approach of encrypting the event stream id and event identifier again helps defend against eavesdroppers and tampering with the event stream (e.g. event injection) from the publisher.

The response to requests determines whether their event has been successfully received by EAL. Bad request is returned if the request is inconsistent in some way. Alternatively, refused request is returned when the unique id of the publisher is not allowed to publish to the specified event stream. The refused request may be returned when the event identifier is not the next expected value in the monotonic sequence. The refused request may be returned when the event specification is invalid for the specified event stream. An event content error is returned when the event contents do not correspond to the event specification. This includes a complete mismatch in data vs specification, missing mandatory attributes, or incorrectly formatted attributes.

If the event content error is returned for an event in a given event stream, then no more events can be published to the event stream until this is fixed, which means that an error must be generated in the publisher process.

Event publication remediation can occur in two ways. For long-lived processes that publish events, the process must have repair facilities to be able to correct the content of the event. Once corrected, the event is resubmitted with the same event identifier (i.e. the next value in the monotonic sequence expected by EAL). For transient processes, the process should include a persistent store of the events it was scheduling to publish. On event publication failure, the process should exit. This allows manual or automated inspections repairs of the event data. Once the events are corrected, a new transient process may be initiated and assigned a new unique id with EAL. The EAL will attempt to publish the scheduled events before publishing any new ones that it generates itself.

A subscriber may discovery which event streams they can consume from by calling on a discovery API on the EEP abstraction layer (EAL). When the subscriber makes this request, the EAL verifies the request through a combination of encryption keys and unique identifiers check. Subsequently, the EAL may utilize access control rules to filter out eligible event streams for the subscriber only. In an example, the triple parameters of the subscriber (unique ID, event stream ID, event ID) may inherently limit what events streams may be available. The available event stream details are encrypted, signed and returned to the subscriber. This allows the subscriber to confirm the response is valid.

In some examples, a subscriber might not be able to access any event streams. This may be rare but could happen when the triple parameters of the subscriber does not match any available metadata collected by the event abstraction layer. However, the combination of the subscriber's ID and their permitted metadata access may ensure the available event streams are policy compliant to their jurisdiction and domain.

The EEP abstraction layer may be designed with a specific set of behaviors to achieve the subject goals of securely coordinating events across jurisdiction and domains. The concept of an event stream is distinct from any implementation approach within the EEP. This allows the EAL to be flexible in how the event stream is implemented internally, subject to its first-in-first-out (FIFO) behavior.

Each EAL instance may be assigned a unique identity, as defined by the key pairs issued to them by the IdP. This ensures each EAL instance can communicate securely and verifiably with each other. Additionally, it means that each EAL can create and securely store AES-GCM keys using its ECDSA private key, allowing the key to recovered.

In various examples, key recovery may allow the process to restart.

In the disclosed Enterprise Event Platform (EEP), secure event distribution across jurisdictional boundaries may be achieved through advanced cryptographic mechanisms, specifically leveraging ECDH (Elliptic Curve Diffie-Hellman) and ECDSA (Elliptic Curve Digital Signature Algorithm) key interactions.

The EEP may be configured to facilitate subscriber registration and identities. Each subscriber generates a static ECDH keypair and registers their public key with the platform's identity registry (PKI/DID). The subscriber may also register an ECDSA signing keypair for mutual authentication. Upon registration, the platform issues a unique subscriber identifier, binding identity, location, and use case, and stores the public keys for future event delivery.

The EEP may be configured to facilitate event publication and envelope constructions. The publisher retrieves the subscriber's ECDH public key from the registry. For each event, the publisher generates an ephemeral ECDH keypair, computes a shared secret with the subscriber's public key, and derives a per-event AES-GCM content encryption key (CEK) using HKDF-SHA256, in an example. The event payload may be encrypted with AES-GCM using the CEK. The publisher signs the envelope (including metadata, ephemeral public key, IV, ciphertext, and recipient list) using their ECDSA private key, ensuring integrity and authenticity. The broker receives and relays the envelope, which contains only encrypted data and metadata; it cannot decrypt the payload.

The EEP may be configured to facilitate subscriber event consumptions. The subscriber receives the envelope, verifies the publisher's ECDSA signature using the publisher's public key. The subscriber computes the shared secret using their ECDH private key and the publisher's ephemeral public key, derives the CEK, and decrypts the payload. Replay protection is enforced by checking message IDs and timestamps.

The EEP may incorporate a number of unique design aspects. Per-event ephemeral ECDH keys provide forward secrecy; compromise of a single key does not expose historical events. ECDSA signatures bind the event to the publisher's identity, supporting non-repudiation and auditability. The platform supports per-subscriber, per-use-case access control, with cryptographic isolation between jurisdictions. The broker remains agnostic, unable to access event payloads, supporting compliance with data sovereignty regulations.

The EEP may be configured to facilitate specific event caching considerations. When a publisher publishes an event to an event stream, it sends the event to its local EAL. Once the event is verified as adhering one of the valid event schemas for that event stream, the event is durably cached locally within the EAL.

To ensure that the event data is not accessible nor tampered with, the EAL instance will create or reuse an AES-GCM encryption key that is secured using the ECDSA private key. This means that cached events can be accessed by multiple local instances of the EAL, provided they have access to the same private key. The private key access equates to presenting to the EAL as the same identities.

Cached events may be identified by an identifying pair including an event stream id and an EAL event id, where the EAL event id is unique and distinct from the publisher's identifying triple parameters, including an unique id, event stream id, and event identifier. Importantly, this means that the identity and location of the publisher of event is discarded once the event is accepted. The identity and location of the publisher of event may not be discarded if they are included in the attributes of the event itself.

The EAL may be configured to facilitate specific event streaming considerations. Within the EEP, event streams may be viewed as a first-in-first-out (FIFO) ordered sequence of events. The centralized event broker may hold a “topic” for each event stream, which will contain events expressed only with metadata. This means that globally distributed publishers may publish to the event stream, and there will be a definitive FIFO sequence of events that all consumers of the event stream will experience.

The metadata event created for each actual event may comprise the EAL instance that holds the actual event and the EAL event identifier created by the EAL instance. A published actual event is not considered to have been received by the EAL until the event has been verified, cached and the metadata event published to the event stream's topic on the event broker. Once these steps have been completed, the monotonic counter for the unique id is incremented within the EAL and it responds that the event publication was successful.

The EEP may be configured to facilitate a specific local data platform relationship. EAL instances may be configured to situate inside each jurisdictional boundary. Similarly, an instance of the Data Platform (DP) may be configured to situate inside the same boundary. Therefore, the DP makes a suitable location to manage the long-term event store.

The DP may be a suitable to manage the long-term event store because the data assets created by the DP can be updated as new events arrive, enabling the DP to be to provide a near-time view of data for large scale analytics and operational processing. This may further be supported by the fact that data asset definitions can be consistent to events. In particular in terms of attribute representation, the definition may be consistent to the events, reducing the ETL processing required to create the data assets. This design consideration may enable data consumers to have the same experience whether consuming data assets or events, thus providing a simpler and uniform processing.

Furthermore, the design of the DP allows the EAL to retrieve events when needed, which facilitates event stream replays for “late joiners”. This allows the time-to-live (TTL) for events cached in the EAL to be short, and the cache to operate using the “least recently used” protocol before the TTL expiry, both allowing the local cache size to be reasonably small.

Since the chronology order of data change in data assets must be the same as that for subscribers to event streams, the local DP will itself be a subscriber to the local EAL. Since the local DP is identified as a subscriber to the local EAL, all event streams will be available with no data access controls applied to the events before being passed to the DP. Therefore, there is a high trust relationship between the EEP and the DP.

The subscription mechanism will operate as before, passing secured and verified events to the DP. The subscription approach will ensure that only the local events are passed to the local DP, skipping any events in the event stream that are published from remote publishers to remote EALs.

The DP will store the events it receives using their unique key, including event stream id and EAL event identifier. Additionally, the DP may utilize an API on the EEP that allows the local EAL to request one or more events to be returned, based on their unique key. Only the local EAL is authorized to invoke this API against its local DP.

Therefore, the DP design on the EEP ensures accepted events are always stored securely and durably. Similarly, the EAL transiently holds events locally, for performance reasons. The EAL has access to the full history of all locally published events, via the DP. The DP can generate data assets using the events in its event store that are consistent with events flowing via EEP. Both the DP and EEP are designed to maintain data consistency.

The EEP may be configured to support subscriber event transformation and delivery. As noted above, when a subscriber connects, the local EAL stores details of its one-time ECDH public key. When the subscriber decides to subscribe to a given event stream, a local EAL may ingest the metadata events from the corresponding topic on the event broker within EEP. The metadata events may indicate which EAL instance is holding the actual event.

The local EAL instance can therefore be configured to maintain a cache, for each subscriber, of the EAL instances they will receive events from. If a metadata event is from a previously unknown EAL instance, then the local EAL will securely provide the remote EAL instance with the subscriber's shared AES-GCM key. The AES-GCM key may be derived from the one-time ECDH public key and the local EAL instance's ECDH private key. The local EAL may update a subscriber's access control rules.

The local EAL may request the corresponding event from the remote EAL instance. When the remote EAL instance receives the event retrieval request from the other EAL instance, it may retrieve its securely cached details for the remote subscriber. The remote EAL may apply the access control rules to the event and encrypt the modified event using the shared AES-GCM key. Subsequently, the remote EAL may return this to the local EAL instance.

The subscriber's access control rules may mean that the event cannot be returned at all. In this case the remote EAL will return a suitable response code. When this is received by the subscriber's local EAL instance, it may ignore that event and move to the next metadata event from the event broker. Assuming that a secured event is returned, the local EAL now signs the event and returns it to the subscriber. The subscriber can verify the EAL signed the event and can decrypt it as the event is secured using the shared AES-GCM key that it can recreate.

The remote EAL instance may not be provided information to determine who the subscriber of the event is, nor for what use case. The internal EEP environment is highly trusted, in that AES-GCM keys are being shared. It is crucial therefore that the EEP control plane maintains unique identities for each EAL instance, so that trust can be established between the instances and information can be shared securely.

The EEP may be configured to support subscriber event delivery optimization. The EEP may be configured to continuously request events sequentially from remote EAL instances, which may add latency in terms of event delivery to subscribers. However, once a subscriber has requested an event from the remote EAL instance, all necessary details to create jurisdictionally compliant events for the subscriber are provided to the remote EAL instance. Thus, that instance also knows which local EAL instance the subscriber is using and the event stream. Therefore, the remote EAL can pre-emptively push modified, secured events to the local EAL instance as soon as it receives events from the publisher and has accepted them.

As a result, EAL instances will also have a second cache with short TTL secured events that are created for specific subscribers. When the local EAL processes a metadata event for a subscriber, it will check this second cache for the event, prior to asking the remote EAL for the event. This will significantly reduce latency as perceived by the subscriber.

Occasionally, there will be duplicative processing. Due to the fact that there is an inherent race condition between the push of the event by the remote EAL and the request of the event by the local EAL, duplicative processing may be inevitable. However, the tuning of the EEP may minimize such a condition.

The EEP may be configured to support subscriber replays. Often, subscribers wish to only receive events from the point that they start subscribing to an event stream via the local EAL instance. However, the EAL may be configured to allow an option to specify the starting point from which to consume events.

If the head of the event stream is not determined, then the local EAL will move back through the history of metadata events for the corresponding topic on the EEP event broker, to identify the sequence of events to be retrieved. The local EAL will then sort these by remote EAL instances and issue a single request to each to retrieve all the identified events from that instance. The remote EAL instance will then recreate those events, potentially loading from the remote DP, and applying the subscriber's access control rules. The local EAL will then assemble the correct sequence of events for the subscriber to consume, once the remote EALs have returned their respective event sets.

The EEP may be configured to support location proxying. As the local EAL instances contact remote EAL instances, the approximate location of the subscriber becomes known within the remote jurisdiction. In these cases, intermediate EAL proxies can be established, which act only as “pass-through” but provide an arbitrary location point (i.e. neutral) for the remote jurisdiction. This means that the EEP provides a secure, zero-knowledge environment for both publishers and subscribers (although both are governed via the EEP's control plane).

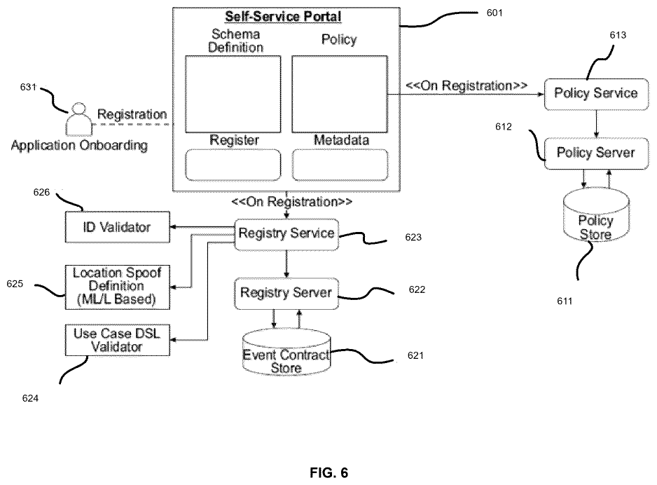

Referring to FIG. 6, a self-service portal may be used by a user to register and access the enterprise event platform (EEP). The self-service portal may comprise a schema definition module, a policy module, a registration module, and a metadata module. The policy module may be connected to a policy server, which in turn may access a policy store.

A policy store may be connected with a policy server to provide policy services. The policy service may be connected to the self-service portal to allow users definite, select, and sort policies. Relevantly, the self-service portal may allow custom interaction of metadata in relation to the policy.

The self-service portal may be connected to a registry service, which may connect to a registry server and an event contract store. The registry service may comprise modules to validate IDs, definite location spoof, and valid use case. The location spoof may further be defined by machine learning basis. A user may process application onboarding via registration on the self-service portal.

The detailed description provided above in connection with the appended drawings is intended as a description of examples and is not intended to represent the only forms in which the present examples can be constructed or utilized.

Supported embodiments include a computer-implemented system for event distribution, comprising an event broker configured to transport metadata, a plurality of event abstraction layer instances, each deployed within a respective jurisdictional boundary, an application programming interface to local publishers and subscribers, configured to validate event content against an event schema, generate a metadata record for events, and publish the metadata record to the event broker, a data access control service configured to model jurisdictional policies as access control rules, and a data platform within each jurisdictional boundary storing event payloads as an authoritative event store, wherein, responsive to a subscription request via a local event abstraction layer instance, the local event abstraction layer instance obtains subscriber access control rules from the data access control service, for each metadata record received from the event broker, requests a corresponding event payload from a remote event abstraction layer instance identified in the metadata record, receives from the remote event abstraction layer instance a transformed event payload tailored to the per-subscriber access control rules, and delivers the transformed event payload to an event stream.

Supported embodiments include a computer-implemented system for event distribution further comprising an identity provider that issues ECDSA and ECDH key pairs for event abstraction layer instances and for subscribers and maintains public keys discoverable by the event abstraction layer instances for verification.

Supported embodiments include a computer-implemented system for event distribution, wherein the event broker stores metadata records comprising an event abstraction layer instance identifier and an event abstraction layer event identifier and excludes regulated payload attributes.

Supported embodiments include a computer-implemented system for event distribution, wherein the local event abstraction layer instance validates event payloads against a schema registry, wherein the schema registry is configured for schema versioning and validation.

Supported embodiments include a computer-implemented system for event distribution, wherein durable caching of accepted event payloads by the event abstraction layer instance employs AES-GCM encryption with an ECDSA key identity to enable recovery across event abstraction layer boundaries.

Supported embodiments include a computer-implemented system for event distribution, wherein a remote event abstraction layer instance, upon receiving an event payload request for a given subscriber, retrieves the payload from a local data platform instance, applies the per-subscriber access control rules, encrypts the tailored payload using a per-subscriber AES-GCM key, and returns the tailored payload to the requesting event abstraction layer instance.

Supported embodiments include a computer-implemented system for event distribution, wherein the local event abstraction layer instance supports replays for a subscriber from an arbitrary time index by traversing historical metadata records from the event broker, batching retrieval requests to corresponding remote event abstraction layer instances and reassembling an ordered sequence for delivery.

Supported embodiments include a computer-implemented method for event distribution, comprising receiving, at a first event abstraction layer instance within a first jurisdictional boundary, an event payload from a publisher via an event abstraction layer application programming interface, validating the event payload against an event schema and, upon validation, durably caching the event payload within the first jurisdictional boundary, generating a metadata record comprising an identifier for the first event abstraction layer instance and an event abstraction layer event identifier for the event payload, publishing the metadata record to an event broker after removing a regulatory data, receiving, at a second event abstraction layer instance within a second jurisdictional boundary, a subscription request from a subscriber, obtaining, from a data access control service, per-subscriber access control rules based on the subscriber's identity, location, and use case, transmitting, for each metadata record consumed from the event broker, a retrieval request from the second event abstraction layer instance to the first event abstraction layer instance, applying, at the first event abstraction layer instance, the per-subscriber access control rules to the event payload to generate a tailored payload, encrypting the tailored payload using a subscriber symmetric key, transmitting the encrypted tailored payload from the first event abstraction layer instance to the second event abstraction layer instance, and delivering, from the second event abstraction layer instance to the subscriber, the tailored payload in for the event stream.

Supported embodiments include a computer-implemented method for event distribution, further issuing an ECDSA and ECDH key pairs for event abstraction layer instances and for subscribers and maintains public keys discoverable by the event abstraction layer instances for verification.

Supported embodiments include a computer-implemented method for event distribution, comprising storing metadata records, in an event broker, comprising an event abstraction layer instance identifier and an event abstraction layer event identifier and excludes regulated payload attributes.

Supported embodiments include a computer-implemented method for event distribution, wherein the local event abstraction layer instance validates event payloads against a schema registry, wherein the schema registry is configured for schema versioning and validation.

Supported embodiments include a computer-implemented method for event distribution, comprising caching of accepted event payloads by the event abstraction layer instance employs AES-GCM encryption with an ECDSA key identity to enable recovery across event abstraction layer restarts.

Supported embodiments include a computer-implemented method for event distribution, comprising retrieving, upon receiving an event payload request for a given subscriber, the payload from a local data platform instance, applies the per-subscriber access control rules, encrypts the tailored payload using a per-subscriber AES-GCM key, and returns the tailored payload to the requesting event abstraction layer instance.

Supported embodiments include a computer-implemented method for event distribution, comprising generating replays for a subscriber from an arbitrary time index by traversing historical metadata records from the event broker, batching retrieval requests to corresponding remote event abstraction layer instances, and reassembling an ordered sequence for delivery.

Supported embodiments include a non-transitory computer-readable medium storing instructions for an event abstraction layer instance, comprising receiving at least one event payload from an event abstraction layer, generating a metadata record from the at least one event payload through the event abstraction layer, publishing the metadata record to an event broker, obtaining subscriber access rules from a data access control service, requesting event payloads from remote event abstraction layer instances identified in metadata records, applying access rules to tailor payloads, encrypting tailored payloads using subscriber specific keys, and delivering tailored payloads to subscribers for an event stream.

Supported embodiments include a non-transitory computer-readable medium storing instructions for an event abstraction layer instance, wherein the instructions further cause the event abstraction layer instance to coordinate with a data platform to store accepted events, retrieve historical payloads for replay, and maintain data residency compliance.

Supported embodiments include a non-transitory computer-readable medium storing instructions for an event abstraction layer instance, wherein the instructions further cause the event abstraction layer instance to mask, redact, or deny attributes in an event payload according to jurisdiction rules prior to encryption for delivery to the subscriber.

Supported embodiments include a non-transitory computer-readable medium storing instructions for an event abstraction layer instance, wherein the instructions further cause the event abstraction layer instance to implement location proxying through intermediary event abstraction layer nodes to mask subscriber location in cross jurisdiction retrievals.

Supported embodiments include a non-transitory computer-readable medium storing instructions for an event abstraction layer instance, wherein the instructions comprise caching of accepted event payloads by the event abstraction layer instance employs AES-GCM encryption with an ECDSA key identity to enable recovery across event abstraction layer boundaries.

Supported embodiments include a non-transitory computer-readable medium storing instructions for an event abstraction layer instance, wherein the instructions comprise retrieving, upon receiving an event payload request for a given subscriber, the payload from a local data platform instance, applies the subscriber access control rules, encrypts the tailored payload using a subscriber AES-GCM key, and returns the tailored payload to the requesting event abstraction layer instance.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A computer-implemented system for event distribution, comprising:
an event broker configured to transport metadata,
a plurality of event abstraction layer instances, each deployed within a respective jurisdictional boundary,
an application programming interface to local publishers and subscribers, configured to validate event content against an event schema, generate a metadata record for events, and publish the metadata record to the event broker,
a data access control service configured to model jurisdictional policies as access control rules, and
a data platform within each jurisdictional boundary storing event payloads as an authoritative event store,
wherein,
responsive to a subscription request via a local event abstraction layer instance, the local event abstraction layer instance obtains subscriber access control rules from the data access control service,
for each metadata record received from the event broker, requests a corresponding event payload from a remote event abstraction layer instance identified in the metadata record,
receives from the remote event abstraction layer instance a transformed event payload tailored to the per-subscriber access control rules, and
delivers the transformed event payload to an event stream.

2. The system of claim 1, further comprising an identity provider that issues ECDSA and ECDH key pairs for event abstraction layer instances and for subscribers and maintains public keys discoverable by the event abstraction layer instances for verification.

3. The system of claim 1, wherein the event broker stores metadata records comprising an event abstraction layer instance identifier and an event abstraction layer event identifier and excludes regulated payload attributes.

4. The system of claim 1, wherein the local event abstraction layer instance validates event payloads against a schema registry, wherein the schema registry is configured for schema versioning and validation.

5. The system of claim 1, wherein durable caching of accepted event payloads by the event abstraction layer instance employs AES-GCM encryption with an ECDSA key identity to enable recovery across event abstraction layer boundaries.

6. The system of claim 1, wherein a remote event abstraction layer instance, upon receiving an event payload request for a given subscriber, retrieves the payload from a local data platform instance, applies the per-subscriber access control rules, encrypts the tailored payload using a per-subscriber AES-GCM key, and returns the tailored payload to the requesting event abstraction layer instance.

7. The system of claim 1, wherein the local event abstraction layer instance supports replays for a subscriber from an arbitrary time index by traversing historical metadata records from the event broker, batching retrieval requests to corresponding remote event abstraction layer instances and reassembling an ordered sequence for delivery.

8. A computer-implemented method for event distribution, comprising:
receiving, at a first event abstraction layer instance within a first jurisdictional boundary, an event payload from a publisher via an event abstraction layer application programming interface,
validating the event payload against an event schema and, upon validation, durably caching the event payload within the first jurisdictional boundary,
generating a metadata record comprising an identifier for the first event abstraction layer instance and an event abstraction layer event identifier for the event payload,
publishing the metadata record to an event broker after removing a regulatory data,
receiving, at a second event abstraction layer instance within a second jurisdictional boundary, a subscription request from a subscriber,
obtaining, from a data access control service, per-subscriber access control rules based on the subscriber's identity, location, and use case,
transmitting, for each metadata record consumed from the event broker, a retrieval request from the second event abstraction layer instance to the first event abstraction layer instance,
applying, at the first event abstraction layer instance, the per-subscriber access control rules to the event payload to generate a tailored payload,
encrypting the tailored payload using a subscriber symmetric key,
transmitting the encrypted tailored payload from the first event abstraction layer instance to the second event abstraction layer instance, and
delivering, from the second event abstraction layer instance to the subscriber, the tailored payload in for the event stream.

9. The method of claim 8, further issuing an ECDSA and ECDH key pairs for event abstraction layer instances and for subscribers and maintains public keys discoverable by the event abstraction layer instances for verification.

10. The method of claim 8, comprising storing metadata records, in an event broker, comprising an event abstraction layer instance identifier and an event abstraction layer event identifier and excludes regulated payload attributes.

11. The method of claim 8, wherein the local event abstraction layer instance validates event payloads against a schema registry, wherein the schema registry is configured for schema versioning and validation.

12. The method of claim 8, comprising caching of accepted event payloads by the event abstraction layer instance employs AES-GCM encryption with an ECDSA key identity to enable recovery across event abstraction layer restarts.

13. The method of claim 8, comprising retrieving, upon receiving an event payload request for a given subscriber, the payload from a local data platform instance, applies the per-subscriber access control rules, encrypts the tailored payload using a per-subscriber AES-GCM key, and returns the tailored payload to the requesting event abstraction layer instance.

14. The method of claim 8, comprising generating replays for a subscriber from an arbitrary time index by traversing historical metadata records from the event broker, batching retrieval requests to corresponding remote event abstraction layer instances, and reassembling an ordered sequence for delivery.

15. A non-transitory computer-readable medium storing instructions for an event abstraction layer instance, comprising:
receiving at least one event payload from an event abstraction layer,
generating a metadata record from the at least one event payload through the event abstraction layer,
publishing the metadata record to an event broker,
obtaining subscriber access rules from a data access control service,
requesting event payloads from remote event abstraction layer instances identified in metadata records,
applying access rules to tailor payloads,
encrypting tailored payloads using subscriber specific keys, and
delivering tailored payloads to subscribers for an event stream.

16. The non-transitory computer-readable medium of claim 15, wherein the instructions further cause the event abstraction layer instance to coordinate with a data platform to store accepted events, retrieve historical payloads for replay, and maintain data residency compliance.

17. The non-transitory computer-readable medium of claim 15, wherein the instructions further cause the event abstraction layer instance to mask, redact, or deny attributes in an event payload according to jurisdiction rules prior to encryption for delivery to the subscriber.

18. The non-transitory computer-readable medium of claim 15, wherein the instructions further cause the event abstraction layer instance to implement location proxying through intermediary event abstraction layer nodes to mask subscriber location in cross jurisdiction retrievals.

19. The non-transitory computer-readable medium of claim 15, wherein the instructions comprise caching of accepted event payloads by the event abstraction layer instance employs AES-GCM encryption with an ECDSA key identity to enable recovery across event abstraction layer boundaries.

20. The non-transitory computer-readable medium of claim 15, wherein the instructions comprise retrieving, upon receiving an event payload request for a given subscriber, the payload from a local data platform instance, applies the subscriber access control rules, encrypts the tailored payload using a subscriber AES-GCM key, and returns the tailored payload to the requesting event abstraction layer instance.
